(19) United States
(12) Patent Application Publication
(10) Pub. No.: US 2026/0194876 A1
(43) Pub. Date: Jul. 9, 2026

(54) SOFT PARAMETERIZATION OF DEADBANDS IN SENSORS

(71) Applicant: INTERNATIONAL BUSINESS MACHINES CORPORATION, Armonk, NY (US)

(72) Inventors: Rajesh Kumar Saxena, Mumbai (IN); Harish Bharti, Pune (IN); Shilpa Shetty, Sydney (AU); Sandeep Sukhija, Rajasthan (IN)

(21) Appl. No.: 19/011,133

(22) Filed: Jan. 6, 2025

(51) Int. Cl. G05B 19/042

(52) U.S. Cl. CPC G05B 19/042

(57) ABSTRACT

Soft parameterization of deadbands is provided. A configuration file is read. At least one sensor is configured to operate according to a first deadband set of a plurality of deadband sets based on the configuration file. The first deadband set comprises a first plurality of deadband values. A plurality of sensed values is received from the at least one sensor. Each of the plurality of sensed values corresponds to at least one predetermined time period. A probability of sensed values transitioning between one deadband value and another deadband value is determined. A frequency of the plurality of sensed values being one of the first plurality of deadband values within the at least one predetermined time period is determined. The frequency is compared with the probability. The at least one sensor is configured to operate according to a second deadband set of the plurality of deadband sets based on the comparison.

### BACKGROUND

Embodiments of the present disclosure relate to deadbands, and more specifically, to soft parameterization of deadbands in sensors.

A deadband in a sensor is a range of values within which the sensor output remains constant, despite changes in the input variable. In other words, the deadband can be a zone or region of insensitivity or non-responsiveness of the sensor.

Deadbands are often used in sensors to reduce the effects of noise and fluctuations in the input variable. By ignoring small changes within the deadband, the sensor can provide more stable and accurate measurements. Deadbands can also help to reduce the frequency of adjustments or interventions needed in a control system.

However, deadbands can also introduce some drawbacks, such as reduced sensitivity and the possibility of overshoots or undershoots in the output signal when the input variable crosses the deadband threshold.

In conventional techniques, deadbands in sensors are configured to be hard parameterized, meaning that they cannot be changed on-the-fly. When deadbands are hard parameterized, it can be difficult to carefully design and set the deadband ranges to balance the trade-offs between sensitivity, stability, and accuracy in a sensor system used for any particular application. Setting suboptimal deadband ranges can lead to insensitivity, instability, and inaccuracy in the sensor systems. Setting deadband ranges in this way can also be energy inefficient, sensor resource intensive, and not optimal for different applications. Therefore, it may be advantageous in the art to be able to dynamically change deadbands in sensors.

### BRIEF SUMMARY

Disclosed herein are methods, systems, and computer program products that allow deadbands in sensors to be soft parameterized, so that the deadband ranges can be changed dynamically and automatically. Setting deadbands in this way can balance sensitivity, stability, and accuracy in a sensor system used for different applications. Such dynamic setting of deadband ranges in sensors can allow for the optimization of the utilization of limited sensor resources. Such dynamic setting of deadband ranges in sensors can also be energy efficient, optimal for different applications, and can conserve limited sensor resources.

According to embodiments of the present disclosure, methods of and systems and computer program products for determining sensor deadband values are provided. In various embodiments, a computer-implemented method of determining sensor deadband values is provided. The computer-implemented method comprises the following steps. A configuration file defining a plurality of deadband sets is read. Each deadband set defines a range of values. At least one sensor is configured to operate according to a first deadband set of the plurality of deadband sets based on the configuration file. The first deadband set comprises a first plurality of deadband values within the range of values. A plurality of sensed values is received from the at least one sensor. Each of the plurality of sensed values corresponds to at least one predetermined time period. A probability of sensed values transitioning between one deadband value of the first plurality of deadband values and another deadband value of the first plurality of deadband values is determined. A frequency of the plurality of sensed values being one of the first plurality of deadband values within the at least one predetermined time period is determined. The frequency is compared with the probability. The at least one sensor is configured to operate according to a second deadband set of the plurality of deadband sets based on the comparison.

In various embodiments, a system is provided. The system comprises a computing node.

The computing node comprises a computer readable storage medium having program instructions embodied therewith. The program instructions are executable by a processor of the computing node to cause the processor to perform a method. The method comprises the following steps. A configuration file defining a plurality of deadband sets is read. Each deadband set defines a range of values. At least one sensor is configured to operate according to a first deadband set of the plurality of deadband sets based on the configuration file. The first deadband set comprises a first plurality of deadband values within the range of values. A plurality of sensed values is received from the at least one sensor. Each of the plurality of sensed values corresponds to at least one predetermined time period. A probability of sensed values transitioning between one deadband value of the first plurality of deadband values and another deadband value of the first plurality of deadband values is determined. A frequency of the plurality of sensed values being one of the first plurality of deadband values within the at least one predetermined time period is determined. The frequency is compared with the probability. The at least one sensor is configured to operate according to a second deadband set of the plurality of deadband sets based on the comparison.

In various embodiments, a computer program product for determining sensor deadband values is provided. The computer program product comprises a computer readable storage medium having program instructions embodied therewith. The program instructions are executable by a processor to cause the processor to perform a method. The method comprises the following steps. A configuration file defining a plurality of deadband sets is read. Each deadband set defines a range of values. At least one sensor is configured to operate according to a first deadband set of the plurality of deadband sets based on the configuration file. The first deadband set comprises a first plurality of deadband values within the range of values. A plurality of sensed values is received from the at least one sensor. Each of the plurality of sensed values corresponds to at least one predetermined time period. A probability of sensed values transitioning between one deadband value of the first plurality of deadband values and another deadband value of the first plurality of deadband values is determined. A frequency of the plurality of sensed values being one of the first plurality of deadband values within the at least one predetermined time period is determined. The frequency is compared with the probability. The at least one sensor is configured to operate according to a second deadband set of the plurality of deadband sets based on the comparison.

### BRIEF DESCRIPTION OF THE DRAWINGS

FIG. 1 is a schematic illustrating a plurality of deadband sets according to various embodiments of the present disclosure.

FIG. 2 is a flow diagram illustrating a method for determining sensor deadband values according to various embodiments of the present disclosure.

FIG. 3 is a flowchart illustrating a method for determining sensor deadband values according to various embodiments of the present disclosure.

FIG. 4 is a schematic illustrating an example of a computing node according to various embodiments of the present disclosure.

### DETAILED DESCRIPTION

A deadband in a sensor is a range of values within which the sensor output remains constant, despite changes in the input variable. In other words, the deadband can be a zone or region of insensitivity or non-responsiveness of the sensor.

For example, if a temperature sensor has a deadband of 2 degrees Celsius, then the output of the sensor will remain constant within a temperature range of +/−1 degree Celsius from the setpoint temperature. Only when the temperature changes by more than 2 degrees Celsius will the sensor output change.

Deadbands can be used in sensors to reduce the effects of noise and fluctuations in the input variable as described above. Deadbands can also assist in reducing the frequency of adjustments or interventions in a system, such as a control system, that can make use of sensors and their measurements. By ignoring small changes within the deadband, the sensors can provide more stable and accurate measurements, ultimately preventing any unintentional actions from taking place within the system based on such measurements.

However, hard-set, unchanging deadbands in a sensor can have potential drawbacks in an application for which the sensor is used. For example, inappropriately set deadband values for a particular application can result in drawbacks such as reduced sensitivity and the possibility of overshoots or undershoots in the output signal when the input variable crosses the deadband threshold. Therefore, it is important to carefully consider the application for which a sensor is being implemented when designing and setting deadband values to balance the trade-offs between sensitivity, stability, and accuracy in a sensor system.

Conventionally, deadbands in a sensor are configured to be hard parameterized, meaning that they cannot be changed. However, techniques and systems to determine and dynamically change deadbands in a sensor on-the-fly and on-line (i.e. a sensor with soft parameterized deadbands) can help to overcome the aforementioned drawbacks of hard parameterized sensor deadbands, such as reduced sensitivity and undershoots or overshoots in the output signal.

In various embodiments of the present disclosure, the deadbands in a sensor can be soft-bound and the dynamic range of each deadband range can be calculated. This solution can be based on pre-defined finite sets of deadbands. These sets can be defined with a lower range and maximum range and can have different sizes of sets in between.

In various embodiments, inputs can be provided to a system, such as a Supervisory Control and Data Acquisition (SCADA) system. Based on the type of system from which the inputs are received, the deadband values can be recalibrated and appropriate values for the deadband can be determined.

In various embodiments, a soft-parameterized deadband value can be derived based on deadband sets proportional to their change rate within a time frame.

In various embodiments, a framework can be provided to establish the variance and measure of a deadband, based on the probability of changing of states within a deadband set.

In various embodiments, measurement zones where the fluctuations will be cast as aberrations can be identified. In various embodiments, a method of correcting these zones by soft parameterizing the deadbands can be identified.

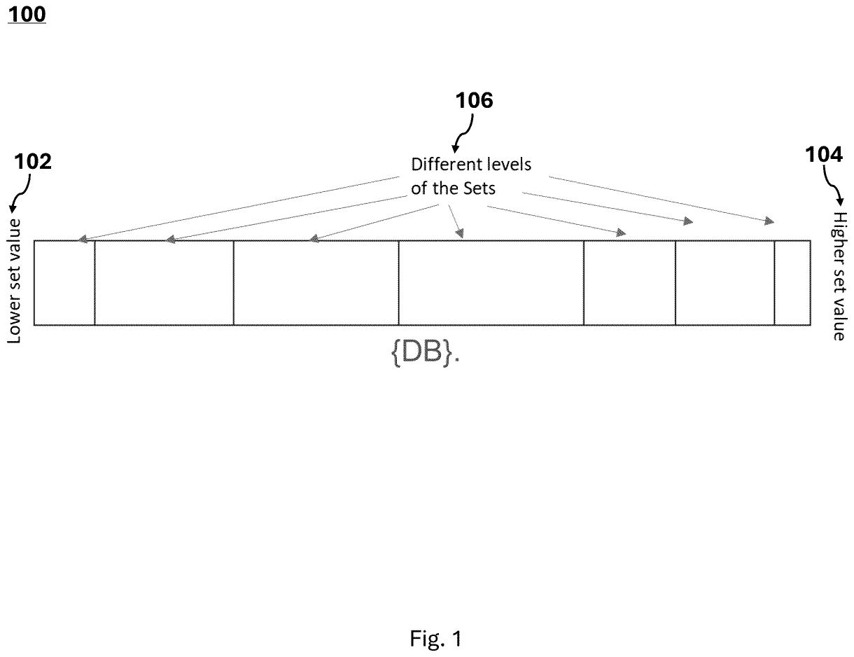

FIG. 1 is a schematic 100 illustrating a plurality of deadband sets according to embodiments of the present disclosure. In various embodiments, at 106, the deadband sets can be referred to as defined levels of the plurality of deadband sets, or “{DB}.” For illustration, as in FIG. 1, the deadband sets can be arranged from left to right in order of increasing set value, going from lower set values 102, to higher set values 104. In various embodiments, a sensor configured to operate according to a deadband set can take only the values defined in that deadband set (“DB”). In various embodiments, one or more instances where these values can be changed without a resulting fluctuation in data can be identified.

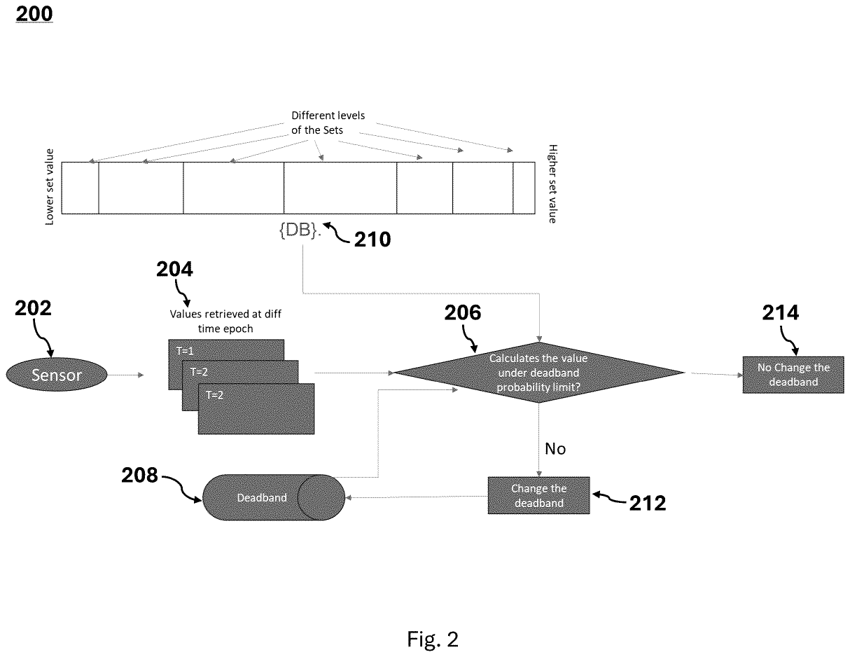

FIG. 2 is a flow diagram 200 illustrating a method for determining sensor deadband values according to various embodiments of the present disclosure. In various embodiments, a sensor, 202, may retrieve multiple sensor/sensed values 204 within one or more time period(s), which can comprise time epoch(s). In various embodiments, at 206, based on one of multiple deadband sets 210, the multiple sensor values 204, and their associated time period(s), a frequency of the sensor values corresponding to a deadband value in the deadband set within a time period may be determined. In particular, the frequency value can be obtained by computing a number of times, within a time period, that a sensed value of the multiple sensed values corresponds to a deadband value of the one of the multiple deadband sets, and then dividing this number by the number of sensed values in the time period.

This frequency value can then be compared against a deadband probability limit at 206. The deadband probability limit can represent the probability distribution of whether the sensed values transition between one deadband value and another as time approaches infinity. This can be obtained by applying a continuous time Markov chain (CTMC) model to the first deadband set and taking a limiting condition of the result, which is described in further detail herein. In various embodiments, at 206, if the frequency value is substantially equal to or above the deadband probability limit, the deadband set may be changed at 212. In various embodiments, at 206, if the frequency value is substantially equal to or below the deadband probability limit, the deadband set may not be changed at 214. In various embodiments, the changed deadband 208 can be used for re-evaluation of the determination made at 206.

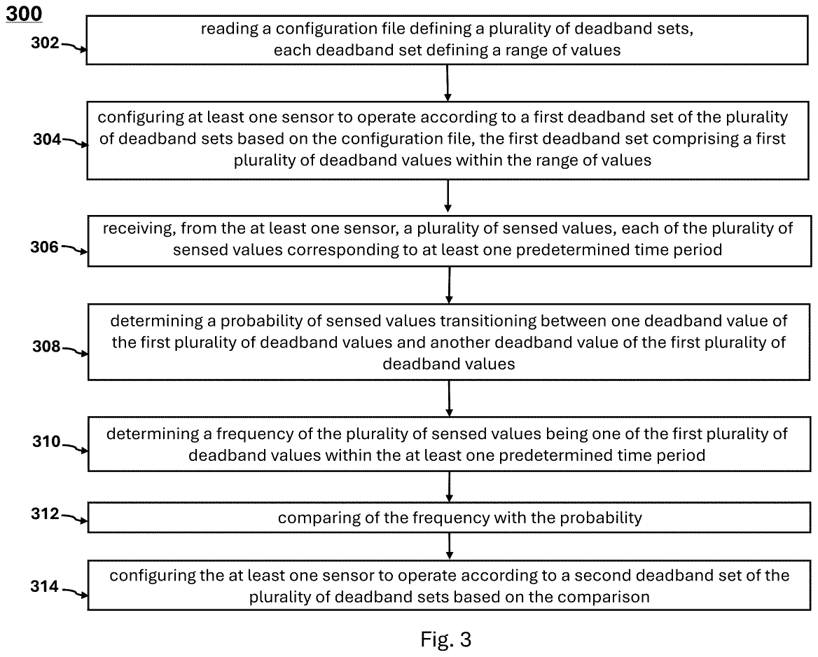

To compute the deadband probability and limit as described above and as implemented in FIG. 3, a Continuous Time Markov Chain (CTMC) can be set up as follows. B=[B₁, B₂ . . . Bₙ]^{T} can be the band matrix that captures the initial states for the sensor. These initial states can be defined, for example, as 0.1%, 0.2%, and so on. R:{B×B}_{≥0} where R can be a rate matrix that defines the rate of change, e.g., which state of the band can be moved to which state. D:B→2^{DB} can describe the labeling for the deadbands, e.g., defining all states that can be reached in the deadbands. The probability of taking a transition from s within t time units can be derived as follows:

$$T ( s ) = {\sum }_{{s}^{Δ} ∈ B} R ( s , \text{?} ) \qquad ( Equation 1 )$$

where [symbol] is the transitionary state from the initial state and s is the initial state that reflects one of the starting band limits of {DB}. If Equation 1 is considered under a CTMC, it can have the following resolution:

$$T ( s ) = 1 - {e}^{- T ( s ) \cdot t} \qquad ( Equation 2 )$$

If within a time period, such as a time epoch, where the state is moving from one deadband value to another at a frequency above the probability limit, then the deadband range can be changed.

A limiting condition of Equation 2, where R (s, [symbol] )>0 for more than one state [symbol] , can be stated as follows:

$${⋃}_{{B}_{i}} \{ [ T ( s ) = 1 - {e}^{- T ( s ) \cdot t} ] v [ R ( s , \text{?} ) ] \} ≫ 0 \qquad ( Equation 3 )$$

Equation 3 above represents the deadband probability limit. If the frequency at which the system actually transitions from one deadband set to the next set is greater than expected (i.e. not below/exceeding the deadband probability limit), then the system can change the deadband range. Under this condition, with one state [symbol] , there can be a race between outgoing transitions from s. That is, the probability of moving from s to [symbol] (given the band Bᵢ) in a single transition can be the probability that the delay of going from s to [symbol] finishes with the delays of any other outgoing transition. It can be in these conditions that Bᵢ is not an adequate capture of the mobilization and the deadband can be set to a next value of B (B=[B₁, B₂ . . . Bₙ]^{T}, that is, Bᵢ₊₁.

FIG. 3 is a flowchart 300 illustrating a method for determining sensor deadband values according to various embodiments of the present disclosure. In various embodiments, at 302, a configuration file defining a plurality of deadband sets can be read. Each deadband set can define a range of values. In various embodiments, at 304, at least one sensor can be configured to operate according to a first deadband set of the plurality of deadband sets based on the configuration file. The first deadband set can comprise a first plurality of deadband values within the range of values. In various embodiments, at 306, a plurality of sensed values can be received from the at least one sensor. Each of the plurality of sensed values can correspond to at least one predetermined time period. In various embodiments, at 308, a probability of sensed values transitioning between one deadband value of the first plurality of deadband values and another deadband value of the first plurality of deadband values can be determined. In various embodiments, at 310, a frequency of the plurality of sensed values being one of the first plurality of deadband values within the at least one predetermined time period can be determined. In various embodiments, at 312, the frequency can be compared with the probability. In various embodiments, at 314, the at least one sensor can be configured to operate according to a second deadband set of the plurality of deadband sets based on the comparison. In various embodiments, a deadband for one or more sensors can be soft calibrated.

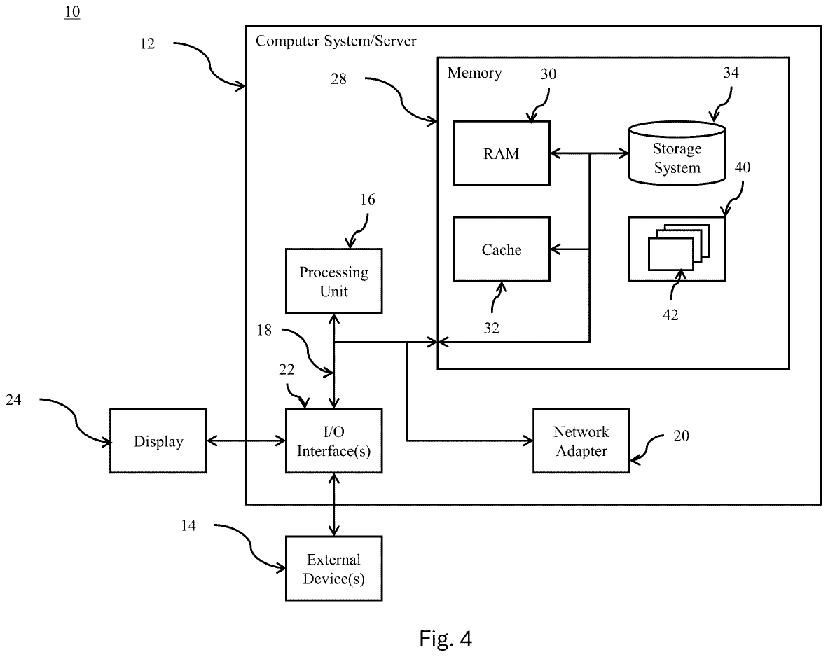

FIG. 4 is a schematic illustrating an example of a computing node according to embodiments of the present disclosure. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of determining sensor deadband values, the method comprising:
reading a configuration file defining a plurality of deadband sets, each deadband set defining a range of values;
configuring at least one sensor to operate according to a first deadband set of the plurality of deadband sets based on the configuration file, the first deadband set comprising a first plurality of deadband values within the range of values;
receiving, from the at least one sensor, a plurality of sensed values, each of the plurality of sensed values corresponding to at least one predetermined time period;
determining a probability of sensed values transitioning between one deadband value of the first plurality of deadband values and another deadband value of the first plurality of deadband values;
determining a frequency of the plurality of sensed values being one of the first plurality of deadband values within the at least one predetermined time period;
comparing of the frequency with the probability; and
configuring the at least one sensor to operate according to a second deadband set of the plurality of deadband sets based on the comparison.

2. The method of claim 1, wherein the first plurality of deadband values is within the defined range of values.

3. The method of claim 1, wherein each deadband set of the plurality of deadband sets comprises a unique plurality of deadband values.

4. The method of claim 1, wherein each of the at least one predetermined time period comprises a time epoch.

5. The method of claim 1, wherein determining the probability comprises:
applying a continuous time Markov chain (CTMC) model to the first deadband set, the CTMC model comprising a label for each of the values in the first deadband set and a rate matrix based on the labels; and
determining the probability based on the rate matrix.

6. The method of claim 1, wherein determining the frequency of the plurality of sensed values being one of the first plurality of deadband values within the at least one predetermined time period comprises:
computing a number of times that each sensed value of the plurality of sensed values corresponds to a deadband value of the first plurality of deadband values within the at least one predetermined time period; and
determining the frequency by dividing the number by a number of the plurality of sensed values.

7. The method of claim 1, wherein configuring the at least one sensor to operate according to a second deadband set of the plurality of deadband sets based on the comparison comprises configuring the at least one sensor to operate according to the second deadband set of the plurality of deadband sets when the frequency exceeds the probability.

8. A system comprising:
a computing node comprising a computer readable storage medium having program instructions embodied therewith, the program instructions executable by a processor of the computing node to cause the processor to perform a method comprising:
reading a configuration file defining a plurality of deadband sets, each deadband set defining a range of values;
configuring at least one sensor to operate according to a first deadband set of the plurality of deadband sets based on the configuration file, the first deadband set comprising a first plurality of deadband values within the range of values;
receiving, from the at least one sensor, a plurality of sensed values, each of the plurality of sensed values corresponding to at least one predetermined time period;
determining a probability of sensed values transitioning between one deadband value of the first plurality of deadband values and another deadband value of the first plurality of deadband values;
determining a frequency of the plurality of sensed values being one of the first plurality of deadband values within the at least one predetermined time period;
comparing of the frequency with the probability; and
configuring the at least one sensor to operate according to a second deadband set of the plurality of deadband sets based on the comparison.

9. The system of claim 8, wherein the first plurality of deadband values is within the defined range of values.

10. The system of claim 8, wherein each deadband set of the plurality of deadband sets comprises a unique plurality of deadband values.

11. The system of claim 8, wherein each of the at least one predetermined time period comprises a time epoch.

12. The system of claim 8, wherein determining the probability comprises:
applying a continuous time Markov chain (CTMC) model to the first deadband set, the CTMC model comprising a label for each of the values in the first deadband set and a rate matrix based on the labels; and
determining the probability based on the rate matrix.

13. The system of claim 8, wherein determining the frequency of the plurality of sensed values being one of the first plurality of deadband values within the at least one predetermined time period comprises:
computing a number of times that each sensed value of the plurality of sensed values corresponds to a deadband value of the first plurality of deadband values within the at least one predetermined time period; and
determining the frequency by dividing the number by a number of the plurality of sensed values.

14. The system of claim 8, wherein configuring the at least one sensor to operate according to a second deadband set of the plurality of deadband sets based on the comparison comprises configuring the at least one sensor to operate according to the second deadband set of the plurality of deadband sets when the frequency exceeds the probability.

15. A computer program product for determining sensor deadband values, the computer program product comprising a computer readable storage medium having program instructions embodied therewith, the program instructions executable by a processor to cause the processor to perform a method comprising:
reading a configuration file defining a plurality of deadband sets, each deadband set defining a range of values;
configuring at least one sensor to operate according to a first deadband set of the plurality of deadband sets based on the configuration file, the first deadband set comprising a first plurality of deadband values within the range of values;
receiving, from the at least one sensor, a plurality of sensed values, each of the plurality of sensed values corresponding to at least one predetermined time period;
determining a probability of sensed values transitioning between one deadband value of the first plurality of deadband values and another deadband value of the first plurality of deadband values;
determining a frequency of the plurality of sensed values being one of the first plurality of deadband values within the at least one predetermined time period;
comparing of the frequency with the probability; and
configuring the at least one sensor to operate according to a second deadband set of the plurality of deadband sets based on the comparison.

16. The computer program product of claim 15, wherein the first plurality of deadband values is within the defined range of values.

17. The computer program product of claim 15, wherein each deadband set of the plurality of deadband sets comprises a unique plurality of deadband values.

18. The computer program product of claim 15, wherein each of the at least one predetermined time period comprises a time epoch.

19. The computer program product of claim 15, wherein determining the probability comprises:
applying a continuous time Markov chain (CTMC) model to the first deadband set, the CTMC model comprising a label for each of the values in the first deadband set and a rate matrix based on the labels; and
determining the probability based on the rate matrix.

20. The computer program product of claim 15, wherein determining the frequency of the plurality of sensed values being one of the first plurality of deadband values within the at least one predetermined time period comprises:
computing a number of times that each sensed value of the plurality of sensed values corresponds to a deadband value of the first plurality of deadband values within the at least one predetermined time period; and
determining the frequency by dividing the number by a number of the plurality of sensed values.

21. The computer program product of claim 15, wherein configuring the at least one sensor to operate according to a second deadband set of the plurality of deadband sets based on the comparison comprises configuring the at least one sensor to operate according to the second deadband set of the plurality of deadband sets when the frequency exceeds the probability.
